(19) United States
(12) Patent Application Publication
(10) Pub. No.: US 2015/0262133 A1
(43) Pub. Date: Sep. 17, 2015

(54) METHOD AND SYSTEM FOR PROVIDING AN ASSESSMENT OF EQUIPMENT IN AN EQUIPMENT FLEET

(71) Applicant: SOLAR TURBINES INCORPORATED, San Diego, CA (US)

(72) Inventor: Christopher John Banchero, San Diego, CA (US)

(73) Assignee: SOLAR TURBINES INCORPORATED, San Diego, CA (US)

(21) Appl. No.: 14/207,055

(22) Filed: Mar. 12, 2014

(51) Int. Cl. G06Q 10/00

(52) U.S. Cl. CPC G06Q 10/20

(57) ABSTRACT

A method for providing an assessment of equipment in an equipment fleet. The method includes receiving an equipment assessment request. The method also includes transmitting fleet summary information representative of equipment in the equipment fleet. The method also includes receiving an input selecting a piece of equipment from the fleet. The method also includes transmitting equipment summary information representing categories of available summary data for the piece of equipment. The method further includes receiving a second input selecting a category of available summary data. The method further includes transmitting detailed data corresponding to the selected category of available summary data.

### TECHNICAL FIELD

The present disclosure relates generally to methods and/or systems for assessing risk and obsolescence in a fleet of equipment, and in particular methods and/or systems for assessing a fleet of oil and gas equipment such as gas turbine engines, compressors, generators, and pumps.

### BACKGROUND

The Oil and Gas industry regularly use fleets of equipment including, gas turbine engines, in order to generate electricity and to drive centrifugal pumps and compressors for oil and gas production. The individual pieces of equipment within the fleet may be dispersed over different geographic locations and may include different equipment installed at different times that must be monitored and managed.

PCT Application Publication No. WO 2013/134709 by Husqvarna Consumer Outdoor Products discloses a fleet management system that assists with management and monitoring fleets of powered machines and their operators, such as fleets engaged in landscaping, grounds care, and forestry service. The system is described as automatically gathering data about one or more pieces of outdoor power equipment and one or more human operators of the equipment. Additionally, the system processes the data into more useful data and data formats, and providing useful feedback, data. The system also provides tools to users of the system via, for example, a web portal that either assists users with management of a fleet of equipment and operators or provides useful information to owner-operators of outdoor power equipment about theft performance and their machines.

The present disclosure is directed toward overcoming one or more of the problems discovered by the inventors or that is known in the art.

### SUMMARY OF THE DISCLOSURE

In one embodiment, the present disclosure is directed to a method for providing an assessment of equipment in an equipment fleet. The method includes receiving an equipment assessment request. The method also includes transmitting fleet summary information representative of equipment in the equipment fleet. The method also includes receiving an input selecting a piece of equipment from the fleet. The method also includes transmitting equipment summary information representing categories of available summary data for the piece of equipment. The method further includes receiving a second input selecting a category of available summary data. The method further includes transmitting detailed data corresponding to the selected category of available summary data.

### BRIEF DESCRIPTION OF THE DRAWINGS

FIG. 1 is a diagram illustrating an example environment with a plurality of computing devices.

FIG. 2 is a flowchart illustrating an example process for providing the assessment and recommendations to a customer.

FIGS. 3-11 are diagrams illustrating example interfaces that could be used in the example process illustrated in FIG. 2.

FIG. 12 is a block diagram illustrating an example computing environment with an example computing device.

### DETAILED DESCRIPTION

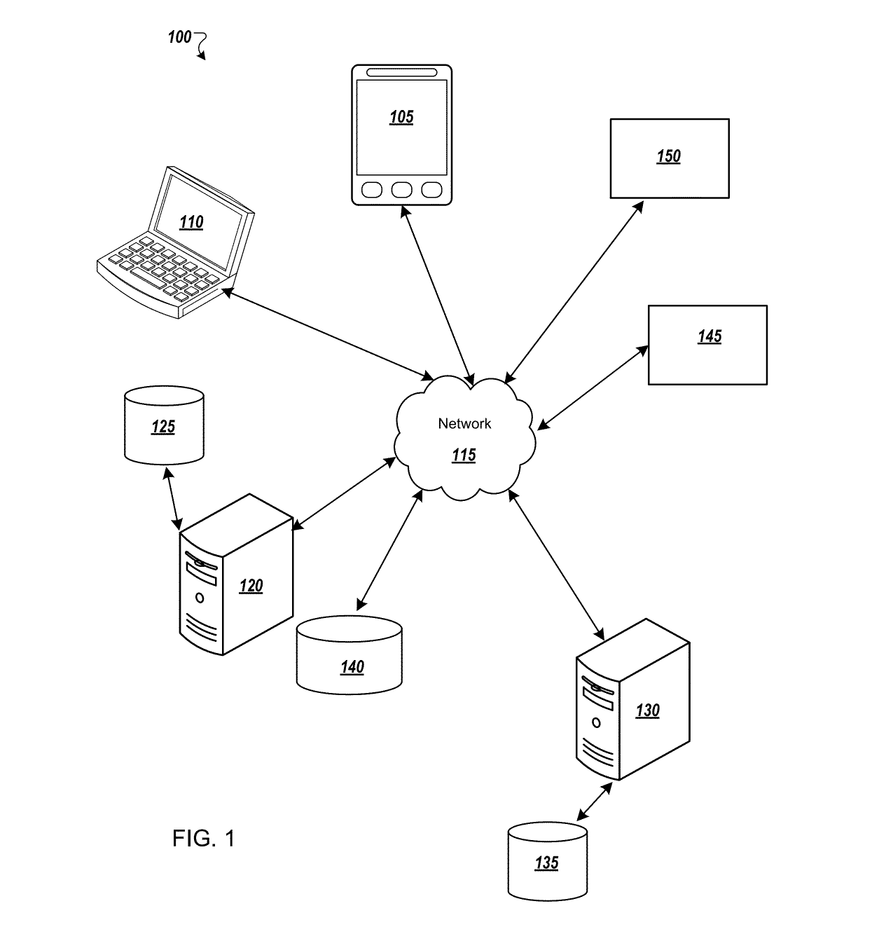

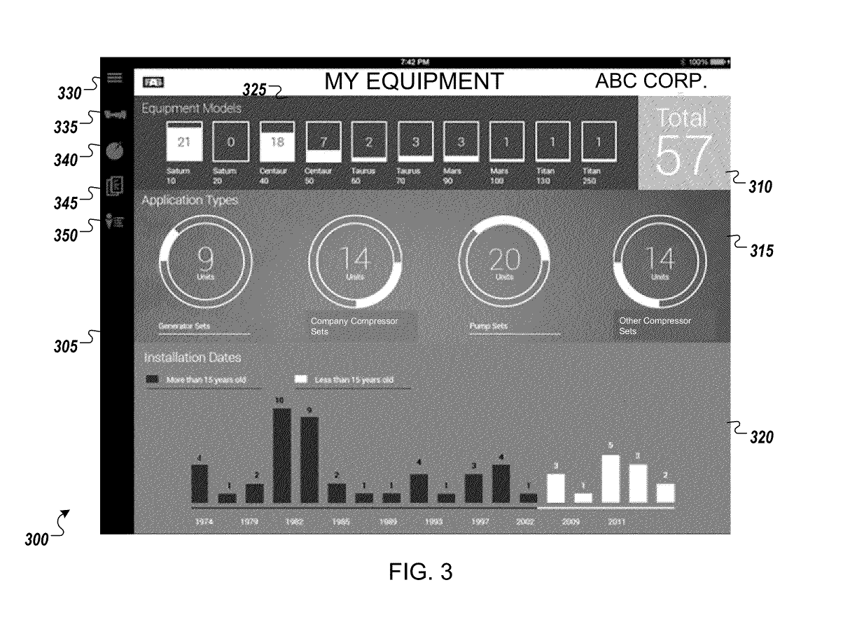

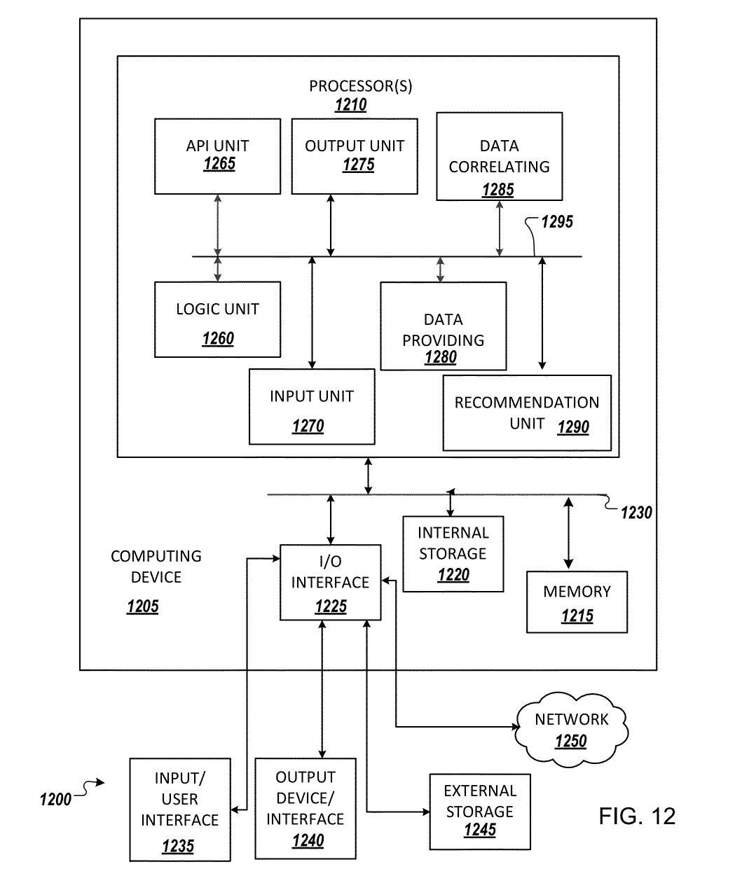

The system and methods disclosed herein include a method and computing devices for assessing and providing recommendations or recommended courses of action for managing a fleet of equipment such as gas turbine engines, compressors, generators, and pumps. The methods and devices disclosed herein may be used to allow a customer such as a fleet manager to access, sort, and review assessment data and recommendations, as well as make decisions on purchasing of repairs, upgrades, and replacement of equipment based on the assessment data and recommendations. A computing device, such as the general computing device disclosed in FIG. 12 may be used in a computing environment, such as the environment disclosed in FIG. 1, to access and review the assessment data. The computing device may display one or more user interfaces, such as those disclosed in FIGS. 3-11, to allow the fleet customer to access, sort, and review the data. The use of the computing device and methods for assessing and providing recommendations, a fleet manager may be able to quickly access detailed information on any piece of equipment in a large fleet in a one place.

FIG. 1 shows an example environment suitable for some example implementations. Computing environment 100 may include multiple customer devices 105, 110 that may be used to access assessment data and recommendations stored on one or more servers 120, 130 via, for example, a network 115 (e.g., by wired and/or wireless connections). The one or more servers 120, 130 may be communicatively connected to one or more storage devices 125 and 135. Additionally, a networked storage device 140 may also be directly accessible via the network 115 without requiring access to a server 120, 130. Additionally, one or more pieces of equipment 145, 150, such a gas turbine engines, compressors, pumps, etc. within a fleet of equipment may also be communicatively connected to one or more of the customer devices 105, 110, servers 120, 130, and the network storage device 140 via the network 115 to send status information and receive control commands.

The customer devices 105, 110 and the servers 120, 130 may be any computing devices including the computing device 1205 described below with respect to FIG. 12. Customer devices 105, 110 may include, but are not limited to, a computer 105 (e.g., a laptop computing device), or a mobile device 110 (e.g., smartphone or tablet). The customer device may also be a smart television, a server computer, or any other computing device that may be apparent.

The servers 120, 130 may be devices associated with an Original Equipment Manufacturer (OEM) or other assessment providers and may be used by the OEM or assessment providers to provide analysis of fleet equipment and/or store data, such as text, text portions, images, image portions, audios, audio segments, videos, video segments, and/or any other information about the fleet equipment). The servers 120, 130 may store assessment data, analysis and recommendations obtained during a fleet assessment in storage devices 125, 135, 140. For example, the servers 120, 130 may store status data uploaded by pieces of fleet equipment 145, 150. Assessment data and recommendations stored on the one or more servers 120, 130 may also include photos, technical data, schematics and other information gathered during equipment location visits by the OEM or other assessment provider at the request of the customer or fleet manager.

A customer (e.g., a fleet manager) may access, view, and/or request content or information on fleet equipment 145, 150 from the servers 120, 130, including real time status data and data gathered during equipment location visits using customer devices 105, 110. Further, the OEM (e.g., a Manufacturer of Gas Turbine Engines) may transmit, display, and/or respond to the customer's requests using servers 120 or 130.

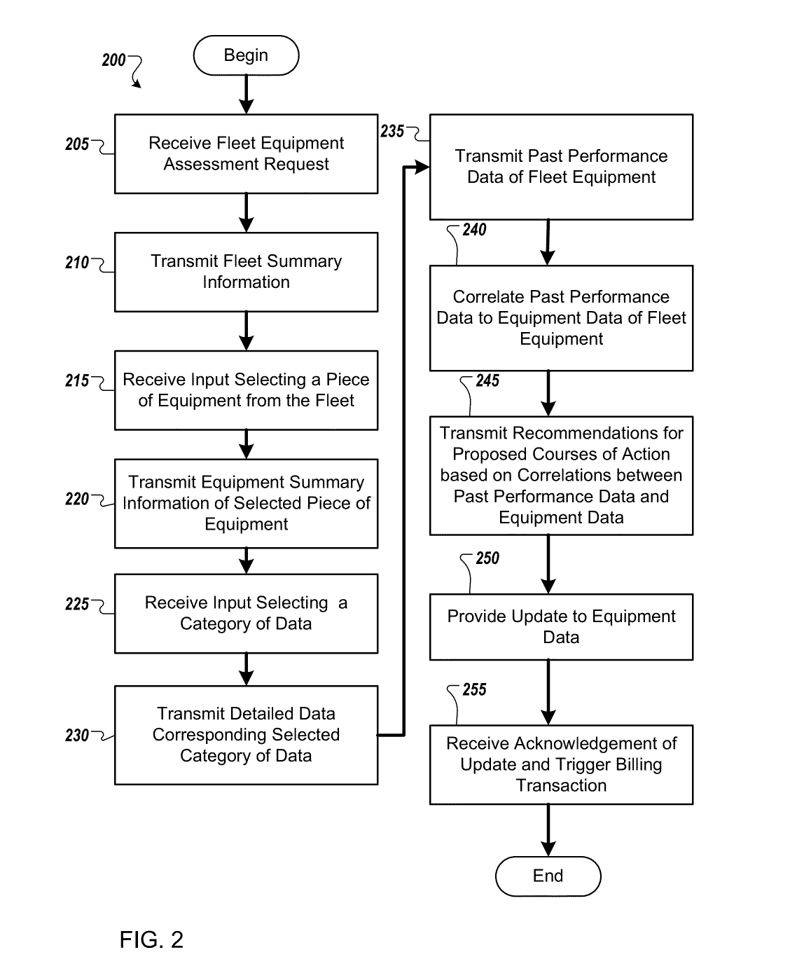

FIG. 2 is an example process 200 for providing the assessment and recommendations to a customer using a computing environment, such as the computing environment 100 described in FIG. 1. In the example process 200, discussed in greater detail below, one or more computer interfaces, such as those illustrated in FIGS. 3-11, may be used to display information to a customer, and allow a user to make selections or request additional information using links, icons and other user interface components that can be clicked or activated by the user as may be apparent to a person of ordinary skill in the art.

FIGS. 3-11 are diagrams illustrating example interfaces that could be displayed on a computing device during the process 200 illustrated in FIG. 2 discussed below. In the process 200 of FIG. 2, two computing devices, such as the computing device 1205 illustrated in FIG. 12 may be in communication in a computing environment, such as the computing environment 100 illustrated in FIG. 1. In the following discussion one of the computing devices may be referred to as the first computing device and one of the computing devices may be referred to as the second computing device.

In FIG. 3, the user interface 300 illustrates an example implementation of a user interface providing an overview of an entire fleet of equipment. The user interface 300 of FIG. 3 includes a navigation bar 305 and a plurality of display sections or display areas 310, 315, 320, 325.

The plurality of sections or areas 310, 315, 320, 325 may display information about the entire fleet. For example, section 310 may display the total number of pieces of equipment in the fleet. Further, section 315 may display a breakdown of the fleet based on how the equipment is being used application (e.g. How many pieces are used as: generators, compressors manufactured by a first company, pumps, and compressors manufactured by companies other than the first company). Section 320 may display the age of the equipment based on installation dates with an indication of how many pieces of equipment are older than a particular threshold (e.g. 15 years) and how many pieces of equipment are younger than the particular threshold. Section 325 may display the equipment fleet composition based on manufacturer or model (e.g. how many pieces of equipment are: a “Saturn model 10”, a “Saturn model 20”, etc.). Example implementations may omit any of these sections and/or may provide alternative information including, but not limited to:
Geographic location of equipment (e.g. how many pieces of equipment are located in particular cities, states, regions, countries, etc.);
Working environment of equipment (e.g. under what conditions is the equipment typically operated, such as tropical environment, desert environment, arctic environment, etc.)
Type of particular subsystems (e.g. how many pieces or equipment use a particular type of combustion system, a particular type of fuel injector, a particular type of control system/display system/fire detection system/gas detection system/vibration system/fuel valve/starter, etc.);
Manufacturing year (e.g. equipment may have been manufactured and installed in different years);
Any other type of fleet overview information that may be apparent to a person of ordinary skill in the art.

The navigation bar 305 may include a plurality of icons, such as 330 which may allow the navigation bar 305 to be expanded or collapsed and icons 335, 340, 345, 350 to allow a user to navigate between different user interfaces. For example, icon 335 may be associated with the fleet summary interface 300 and allow a user to return to the fleet summary interface 300 from other interfaces.

Further, icon 340 may be associated with an assessment status interface indicating how much of the total assessment of the fleet has been completed, and what portions of the assessment have yet to be completed. The fleet assessment status interface is not particularly limited, but may include: percentage indicators of completion of the requested assessment, assessment tasks that have been completed, assessment tasks that have not yet been completed or any other assessment status information that may be apparent to a person of ordinary skill in the art.

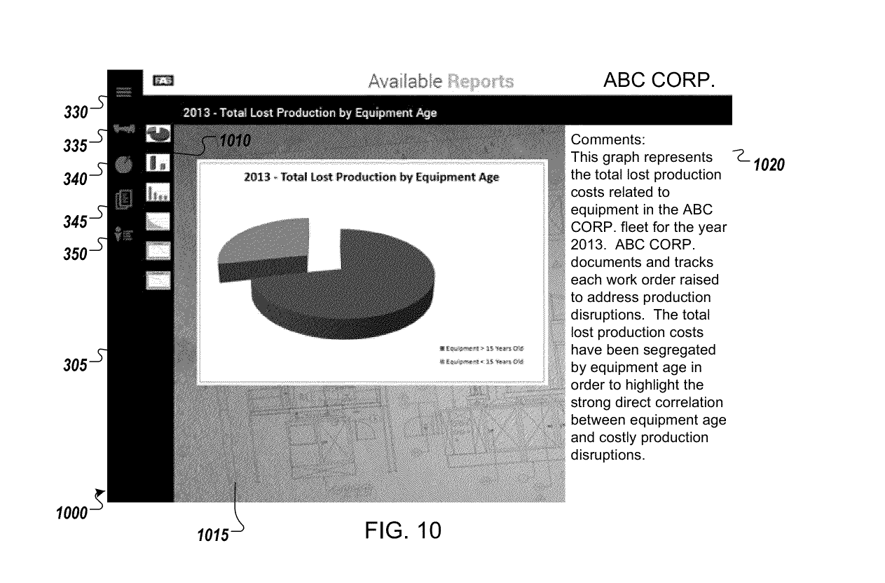

Icon 350 may be associated with and allow navigation to another interface 1000 (illustrated in FIG. 10) providing prior performance information of the equipment and providing access to recommendations based on the assessment. Interface 1000 is discussed in greater detailed below with reference to FIG. 10.

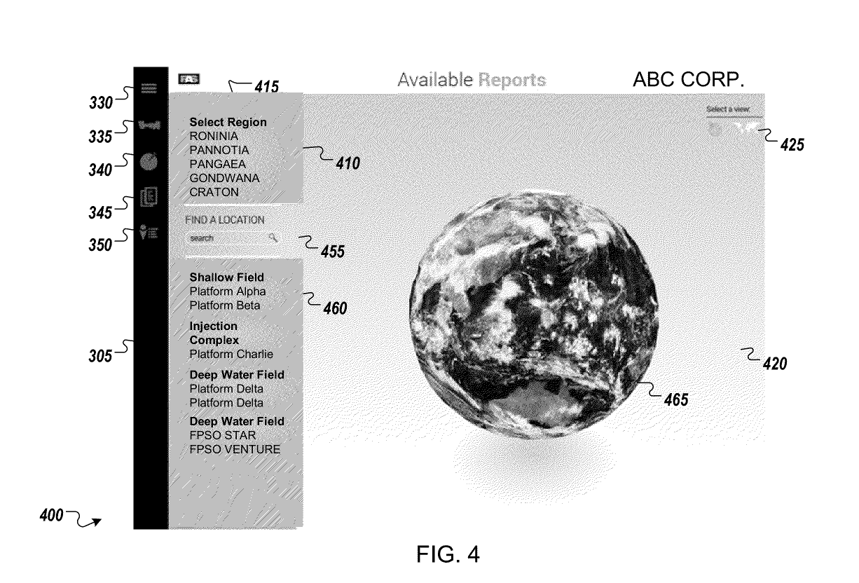

Icon 345 may be associated with and allow navigation to another interface 400 discussed below with respect to FIG. 4.

FIG. 4 illustrates a user interface 400, which provides a visual representation of geographic locations of the equipment within the fleet and links to provide access to more detailed information about individual pieces of equipment that. Like the user interface 300 of FIG. 3, the user interface 400 illustrated in FIG. 4 includes the navigation bar 305. The user interface 400 further includes a display section 420, which provides a visual representation of the geographic location of the equipment of the fleet. For example, in the illustrated implementation, a 3-dimensional globe 465 is provided illustrating the geographic locations of the equipment. In some implementations, the globe 465 may be manipulated by the user using different manipulation techniques. For example, the globe 465 may be rotated using swiping motions, or twisting motions on a touch screen interface, or through the manipulation of a user input device such as a touchpad, trackball, etc. The globe 465 may also allow zoom-in/zoom-out operations using “pinch-pull” motions on a touch screen interface, through manipulation of a user input device (e.g. touchpad, trackball, etc.).

In some implementations, a 2-dimensional map view may be provide in addition to, or as alternative to, the 3-dimensional globe 465 view illustrated in FIG. 4. Additionally, an icon 425 in FIG. 4 may be used to toggle between the 3-dimensional globe 465 view and the 2-dimensional map view in some implementations.

The user interface 400 may also provide a selection menu 415 that allows regions of the globe 465 to be jumped to or selected. The menu 415 may include region selecting section 410 that provides a listing of regions (e.g. Pangaea) of the globe 465 where equipment is located and allowing a user to jump to those regions. The menu 415 may also include a search window 455 to allow a user to search for a particular piece of equipment, or a particular location, or any other the data associated with the equipment of the fleet and jump to the results of any search performed. The menu 415 may also include a listing section 460 of locations (e.g. Shallow Field, Injection Complex, Deep Water Field, etc.) or equipment facilities (e.g. Platform Alpha, Floating production storage and offloading (FPSO) Star, etc.). A user may narrow the displayed geographic locations of equipment using the menu 415 or by manipulating the globe 465.

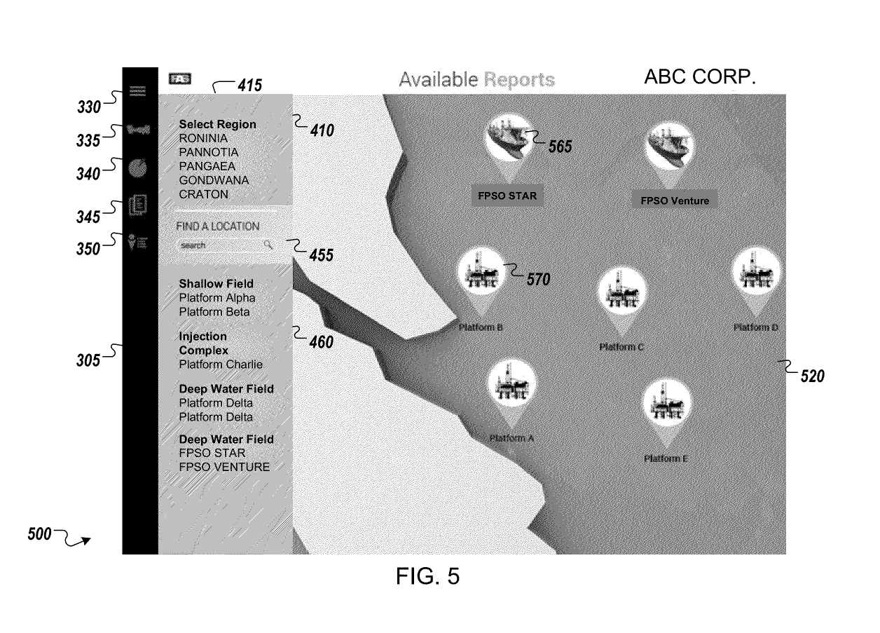

FIG. 5 illustrates another user interface 500 showing a narrowed subset of the displayed geographic locations of equipment. The user interface 500 provides a navigation bar 305 as described above with respect to FIG. 3. The user interface 500 also provides a selection menu 415 as described above with respect to FIG. 4.

The user interface 500 further includes a display section 520, which provides the geographic location of the narrowed subset of equipment of the fleet selected by the user. The display section 520 provides a plurality of icons (including icon 565 and icon 570; for ease of visualization, only two icons have been labeled), which graphically represent specific equipment locations or facilities (e.g. FPSO star, Platform Bravo, etc.).

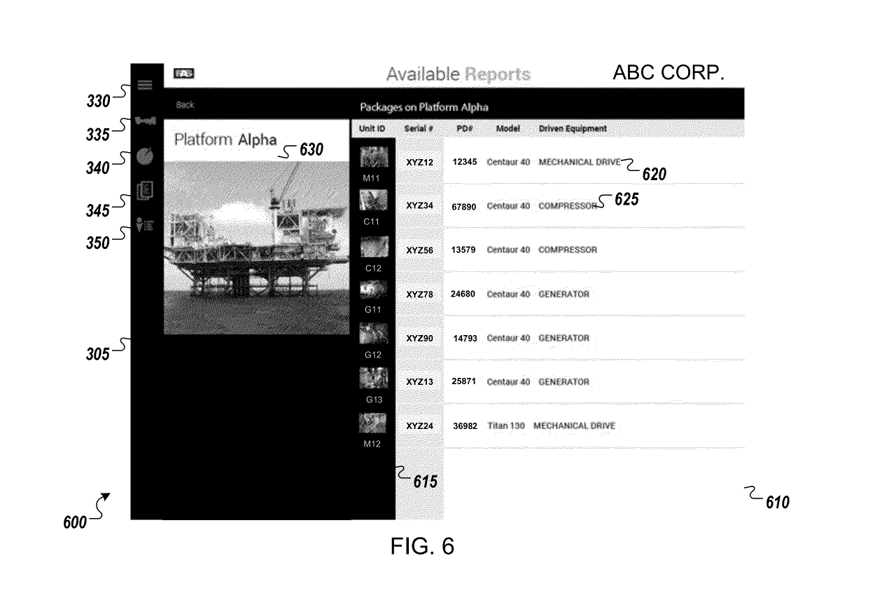

FIG. 6 illustrates another user interface 600 showing the equipment installed at the particular equipment location or facility. The user interface 600 provides a navigation bar 305 as described above with respect to FIG. 3.

The user interface 600 further includes a display section 610 identifying the specific equipment installed at the selected equipment location or facility. The display section 610 may include an Image section 615 providing a small image of each piece of equipment listed. In some implementations, the small image may be enlarged by being selected by the user.

The display section 610 may also include a listing of categories of available summary information or available summary data for each piece of equipment (e.g. 620, 625) installed at the specific location or facility. For example, the display section 610 may provide model information, serial number information, PD number information, and information regarding how the equipment is being used (e.g. as a mechanical drive, as a compressor, as a generator, etc.) Additionally, in some implementations, the user interface 600 may also include a summary section 630 providing information (location, commission date, output information, operation duration) and media (photos, etc.) regarding the location or facility selected.

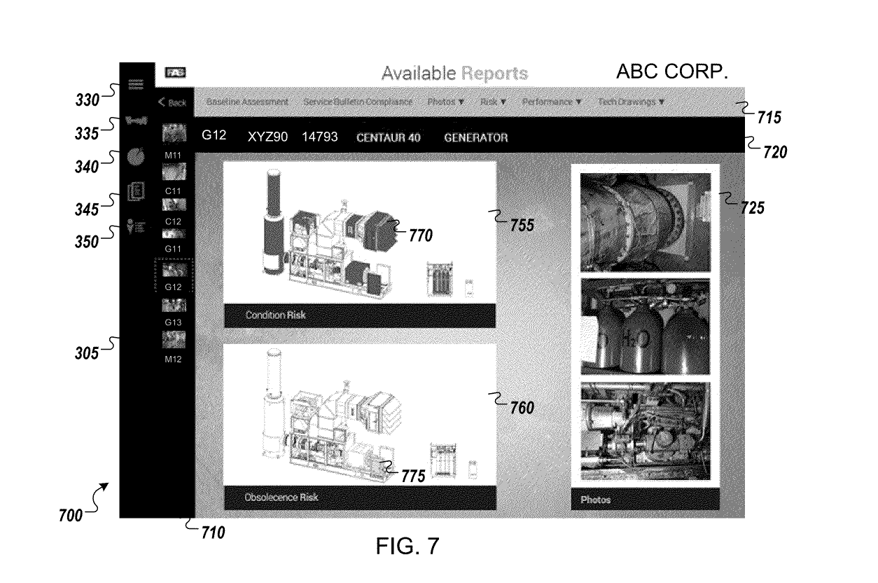

FIG. 7 illustrates another user interface 700 on the second computing device showing available equipment summary information for a selected piece of equipment. The available equipment summary information displayed may include:
Equipment identification information (e.g. Manufacturer information, Model information, serial number information, part number identification, etc.);
Equipment technical information (e.g. Rated performance information, Measured Actual performance information, Identified/known defects or technical bulletins issued by manufacturer since equipment manufactured, type or configuration of equipment or subsystem (such as type of combustion system, a type of fuel injector, a type of control system/display system/fire detection system/gas detection system/vibration system/fuel valve/starter, etc.), and any other technical information that may be useful);
Age of the selected piece of equipment (e.g. when manufactured, when installed, when last repaired, etc.);
Risk of Failure assessment data (e.g. probability of system or subsystem failure based on known technical issues with manufacturer or model, age of equipment, maintenance history, etc.);
Risk of Obsolescence assessment data (e.g. probability that system or subsystems could be difficult or impossible to repair due to type of system or subsystem has become obsolete causing difficulties of finding replacement parts and/or service personnel qualified to repair).

The user interface 700 includes the navigation bar 305 described above with respect to FIG. 3 to allow navigation to other user interfaces.

Further, the user interface 700 may include a menu 710 allowing a user to navigate or jump to other equipment at the same facility or location as the piece of equipment selected. The user interface 700 also includes a menu 715, an equipment summary section 720, and a plurality of display areas 725, 755, 760.

The summary section 720 may provide equipment identification information for the selected piece of equipment (e.g. customer part identification number, equipment serial number, manufacturer production code, model information, etc.) The summary section 720 may also include a summary of how the equipment is being used (e.g. as a generator, compressor, driving a pump etc.).

The display areas 725, 755, 760 may display graphical representations or summaries of the available equipment information or available media. For example, display area 725 may provide small images representing available photos or other media of the equipment or subsystems of the equipment. Further, display area 755 may provide a graphical representation of risk of failure assessment data (e.g. a technical schematic of the equipment with systems or subsystems having greater assessed risks of failure highlight in a different color or grayscale 770). Similarly, display area 760 may provide a graphical representation of risk of obsolescence assessment data (e.g. a technical schematic of the equipment with systems or subsystems having greater assessed risks of obsolescence highlighted in a different color or grayscale 775). Display areas 725, 755, 760 are not limited to these implementations and may provide summaries or graphical representations of any of the data stored on the first computing device.

The menu 715 may provide icons or links that allow a user to navigate to or select detailed information for review. For example, the menu 715 may provide links to technical information such as raw assessment data, compliance with manufacturer defect or service bulletins, risk of failure/obsolescence data, and rated/actual performance data. The menu 715 may also provide links to available media associated with the selected piece of equipment (e.g. photos, technical schematics/drawings, technical manuals, etc.)

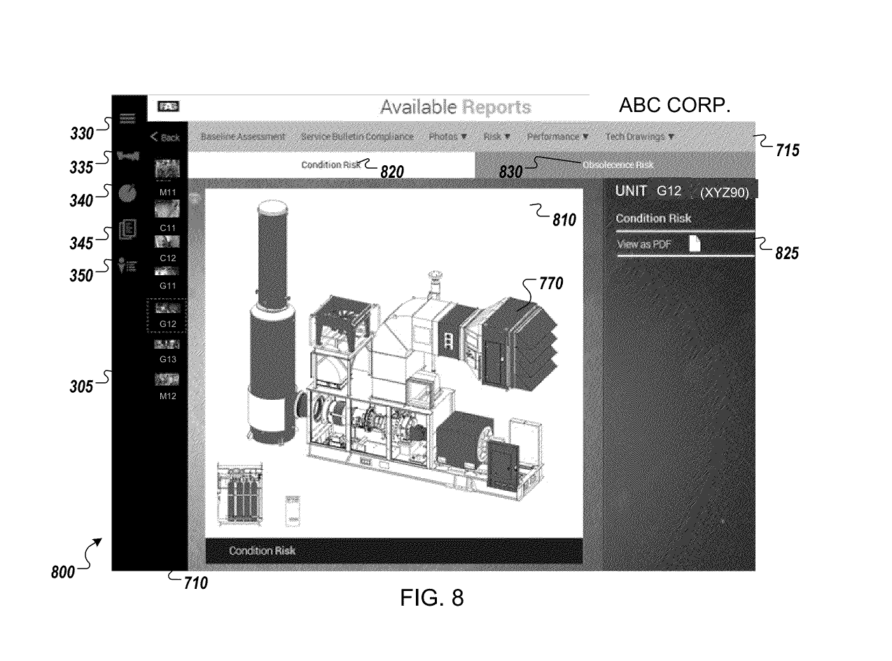

FIG. 8 illustrates a user interface 800 providing a display of detailed data of the risk of failure of equipment systems or subsystems. The user interface 800 includes the navigation bar 305 described above with respect to FIG. 3 to allow navigation to other user interfaces. Further, the user interface 800 may also include the menus 710 and 715 described above with respect to FIG. 7.

The user interface 800 may also include a display area 810, indicator section 820 and a links section 825. The display area 810 displaying the detailed data received from the first computing device, or a graphical representation of the detailed data. For example, the display area 810 may display a graphical representation of risk of failure assessment data (e.g. a technical schematic of the equipment with systems or subsystems having greater assessed risks of failure highlight in a different color or greyscale 770) or may display the detailed data directly.

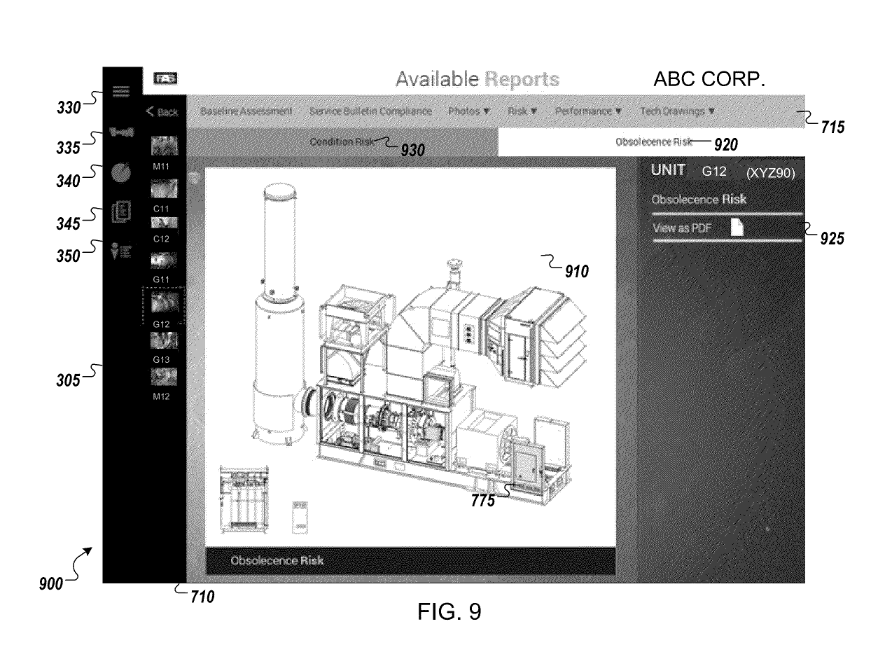

The indicator section 820 may provide identification information for the data being displayed (e.g. Risk of Failure Assessment Data, Risk of Obsolescence data, etc.) Additionally, in some implementations, the indicator section 820 may provide or be proximate to links 830 to related data (e.g. if Risk of Failure Assessment Data is displayed, the indicator section 820 may also include a link 830 to related Risk of Obsolescence Data). A user may use this link 830 to navigate to another user interface 900 (shown in FIG. 9) displaying the related data.

The links section 825 may provide one or more links or icons to allow a user to view or download the data in a file format usable by an external application (e.g. a .txt format, a .doc format, a .pdf format, etc.).

FIG. 9 illustrates a user interface 900 providing a display of detailed data of the risk of obsolescence of equipment systems or subsystems, similar to the user interface 800 illustrated in FIG. 8. The user interface 900 includes the navigation bar 305 described above with respect to FIG. 3 to allow navigation to other user interfaces. Further, the user interface 900 may also include the menus 710 and 715 described above with respect to FIG. 7.

The user interface 900 may also include a display area 910, indicator section 920 and a links section 925. The display area 910 displaying the detailed data received from the first computing device, or a graphical representation of the detailed data. For example, the display area 910 may display a graphical representation of risk of obsolescence assessment data (e.g. a technical schematic of the equipment with systems or subsystems having greater assessed risks of obsolescence highlighted in a different color or grayscale 775) or may display the detailed data directly.

The indicator section 920 may provide identification information for the data being displayed (e.g. Risk of Failure Assessment Data, Risk of Obsolescence data, etc.) Additionally, in some implementations, the indicator section 920 may provide or be proximate to links 930 to related data (e.g. if risk of obsolesce assessment data is displayed, the indicator section 920 may also include a link 930 to related risk of failure data). A user may use this link 930 to navigate to another user interface 800 (shown in FIG. 8) displaying the related data.

The links section 925 may provide one or more links or icons to allow a user to view or download the data in a file format usable by an external application (e.g. a .txt format, a .doc format, a .pdf format, etc.).

The user interfaces 800, 900 illustrated in FIGS. 9 and 10 display risk of failure assessment data, and risk of obsolescence assessment data. However, example implementations are not limited to displaying only this data and may display any data stored on the first computing device.

FIG. 10 illustrates a user interface 1000 providing a display of correlations between estimate lost production due to downtime of the equipment and age of the equipment in the fleet. The user interface 1000 includes the navigation bar 305 described above with respect to FIG. 3 to allow navigation to other user interfaces.

Further, the user interface 1000 may include a menu 1010 allowing a user to navigate or jump to other correlations based on other past performance data and equipment data. The user interface 1000 also includes a plurality of display areas 1015 and 1020.

The display area 1015 may display a graphical representation of the correlations between estimated lost production due to downtime and the age of the equipment. For example, a pie chart may be provided indicating that nearly 75% of lost production was due to equipment 15 years of age or older. Other implementations may use bar charts, line charts, pie charts, or any other type of visual representation of data that may be apparent to a person of ordinary skill in the art.

Display area 1020 may display comments or an explanation of the visual representation displayed in 1015 as well as an explanation of the sources of the data used. For example, the comments may indicate that the chart represents the total lost product costs relating to a particular manufacturer's equipment and is based on data records maintained and provided by the customer. The display area 1020 may also display or imply recommendations transmitted by the first computing device. For example, the recommendation could indicate that there is a strong direct correlation between equipment age and production losses and recommend that equipment be replaced after certain work life (e.g. 15 years).

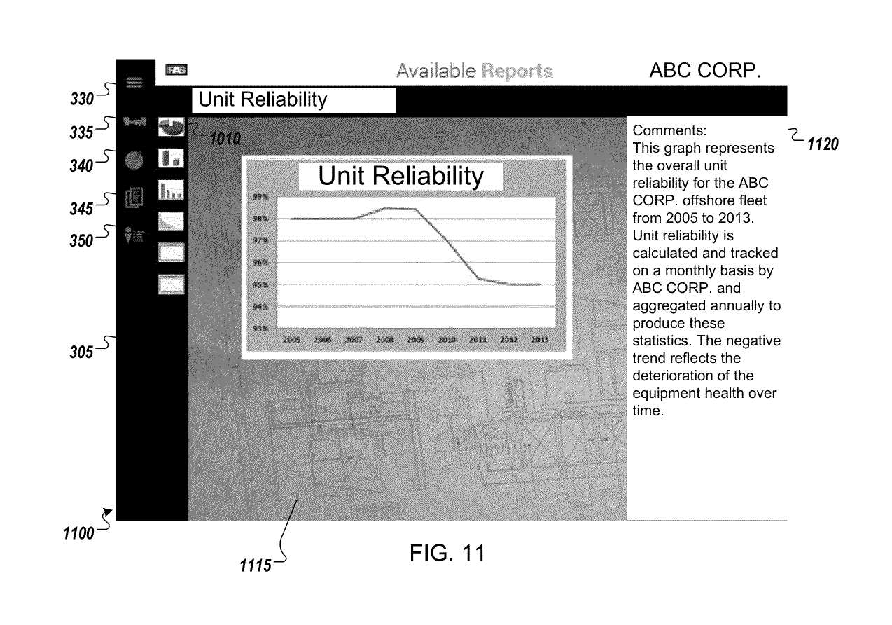

FIG. 11 illustrates another user interface 1100 providing a display of correlations between a manufacturer's equipment's reliability and its age. The user interface 1100 includes the navigation bar 305 described above with respect to FIG. 3 to allow navigation to other user interfaces. Further, the user interface 1100 may also include the menu 1010, which allows a user to navigate or jump to other correlations based on other past performance data and equipment data, discussed above with respect to FIG. 10. The user interface 1100 also includes a plurality of display areas 1115 and 1120.

The display area 1115 may display a graphical representation of the correlations between of a certain manufacturer's equipment's reliability and its age. For example, a line chart may be provided indicating that the manufacturer's equipment was over 98% reliable during the first 5 years of operation, but its reliability has been decreasing every year after that. Other implementations may use bar charts, line charts, pie charts, or any other type of visual representation of data that may be apparent to a person of ordinary skill in the art.

Display area 1120 may display comments or an explanation of the visual representation displayed in 1115 as well as an explanation of the sources of the data used. For example, the comments may indicate that the chart represents a certain manufacturer's equipment's reliability over an 8 year period since installation. The display area 1020 may also display or imply recommendations transmitted by the first computing device. For example, the recommendation could indicate that the chart indicates a negative trend in reliability due to deterioration of the equipment health over time and recommend that equipment be replaced after a certain work life (e.g. 15 years).

The user interfaces 1000, 1100 illustrated in FIGS. 11 and 12 display of correlations and recommendations between a manufacturer's equipment's reliability, production losses and equipment age. However, example implementations are not limited to displaying these correlations and recommendations and may display any data stored on the first computing device.

FIG. 12 is a block diagram illustrating an example computing environment 1200 with at least one computing device 1205 for use in some example implementations. Implementations are not limited to a single computing device 1205 and may include multiple computing devices. The computing device 1205 can include one or more processing units, cores, or processors Error! Reference source not found.1210, memory 1215 (e.g., RAM, ROM, and/or the like), internal storage 1220 (e.g., magnetic, optical, solid state storage, and/or organic), and/or I/O interface 1225, any of which can be coupled on a communication mechanism or bus 1230 for communicating information or embedded in the computing device 1205.

Computing device 1205 can be communicatively coupled to input/user interface 1235 and output device/interface 1240. Either one or both of input/user interface 1235 and output device/interface 1240 can be a wired or wireless interface and can be detachable. Input/user interface 1235 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1240 may include a display, television, monitor, printer, speaker, braille, or the like. In some example implementations, input/user interface 1235 and output device/interface 1240 can be embedded with or physically coupled to the computing device 1205. In other example implementations, other computing devices may function as or provide the functions of input/user interface 1235 and output device/interface 1240 for a computing device 1205.

Examples of computing device 1205 may include, but are not limited to, mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computing device 1205 can be communicatively coupled (e.g., via I/O interface 1225) to external storage 1245 and network 1250 for communicating with any number of networked components, devices, and systems, including one or more computing devices of the same or different configuration. Computing device 1205 or any connected computing device can be functioning as, providing services of, or referred to as a server, client, thin server, general machine, special-purpose machine, or another label.

I/O interface 1225 can include, but is not limited to, wired and/or wireless interfaces using any communication or I/O protocols or standards (e.g., Ethernet, 802.11x, Universal System Bus, WiMAX, modem, a cellular network protocol, and the like) for communicating information to and/or from at least all the connected components, devices, and network in computing environment 1200. Network 1250 can be any network or combination of networks (e.g., the Internet, local area network, wide area network, a telephonic network, a cellular network, satellite network, and the like).

Computing device 1205 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 1205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1210 can execute under any operating system (OS) (not shown), in a native or virtual environment. One or more applications can be deployed that include logic unit 1260, application programming interface (API) unit 1265, input unit 1270, output unit 1275, data providing unit 1280, data correlating unit 1285, recommendation unit 1290, and inter-unit communication mechanism 1295 for the different units to communicate with each other, with the OS, and with other applications (not shown). For example, data providing unit 1280, data correlating unit 1285, and recommendation unit 1290 may implement one or more processes shown in FIG. 2 below. The described units and elements can be varied in design, function, configuration, or implementation and are not limited to the descriptions provided.

In some example implementations, when information or an execution instruction is received by API unit 1265, it may be communicated to one or more other units (e.g., logic unit 1260, input unit 1270, output unit 1275, data providing unit 1280, data correlating unit 1285, and recommendation unit 1290). For example, as discussed in greater detail below, the input unit 1270 may receive inputs from another (second) computing device including fleet assessment requests, and selections pieces of equipment or data categories. The output unit 1275 may transmit responses to the inputs received by the input unit 1265. The data providing unit 1280, in cooperation with the output unit 1275, may provide equipment data stored in the internal storage unit 1220 to the second computing device in response to the inputs received by the input unit 1265. Further, the data correlating unit 1285 may correlate the equipment data stored in the internal storage unit 1220 to past performance data and the recommendation unit 1290, in cooperation with the output unit 1275, send recommendations to the second computing device based on the correlations performed by the data correlating unit 1285.

In some instances, logic unit 1260 may be configured to control the information flow among the units and direct the services provided by API unit 1265, input unit 1270, output unit 1275, data providing unit 1280, data correlating unit 1285, and recommendation unit 1290 in some example implementations described above. For example, the flow of one or more processes or implementations may be controlled by logic unit 1260 alone or in conjunction with API unit 1265.

### INDUSTRIAL APPLICABILITY

Industrial machines, such as gas turbine engines, may be suited for any number of industrial applications such as the oil and gas industry (including transmission, gathering, storage, withdrawal, and lifting of oil and natural gas), the power generation industry, cogeneration, aerospace, and other transportation industries. Therefore, large entities in these fields may have fleets of equipment being used in different applications spread out over globe. As equipment ages, these entities may request OEMs of the equipment, or third party consultants, to assess all of the equipment and provide recommendations on improving efficiencies of the fleet to reduce operating losses.

During these assessments, the OEM or consultants dispatch technicians to all of the facilities or locations where the equipment may be to thoroughly investigate the entire fleet. This investigation may frequently involve taking hundreds or even thousands of pictures of the equipment onsite, and collecting detailed technical records and technical data regarding all systems and subsystems of the equipment. In addition to collecting records and data on the specific equipment, the investigation will also sometimes include the collection of performance history data relating to the equipment. For example, some customers may also allow the OEM or the consultants to access maintenance records for the equipment indicating how frequently maintenance has been performed or how often repairs have been needed. Further, some customers may also provide the OEM or the consultants with access to business records indicating daily, weekly, monthly, or yearly production, profits or losses over a given time period.

Once all of this information has been collected or generated by the consultants, the OEM or consultants analyze the data to assess the entire fleet and provide recommendations for repairs, upgrades, or replacement of part or all of the fleet. In some situations, however, customers want to retain access to the large volume of data collected to allow the customer to monitor and track all of the equipment in the fleet.

FIG. 2 is an example process 200 for providing the assessment and recommendations to a customer according to an example implementation. In the process 200 of FIG. 2, two computing devices, such as the computing device 1205 illustrated in FIG. 12 are in communication in a computing environment 100, such as the computing environment 100 illustrated in FIG. 1. Though the process blocks may be arranged or described in a particular order or sequence, the process 200 is not limited to the particular order or sequence shown and/or described. Additionally, one or more process blocks may be omitted skipped or bypassed based customer input as may be apparent to a person of ordinary skill in the art.

In some implementations, the first computing device or collection of computing devices may be considered a device associated with an OEM or consultant, such as servers 120, 130 illustrated in FIG. 1. Further, the second computing device may be considered a customer device owned or given to the customer by the OEM or consultant, such as customer devices 105, 110 illustrated in FIG. 1. Generally, the first computing device may generate, organize and transmit the data in response to a received input signal or other communications transmitted from the second computing device in response to user requests made using a user interface.

In the process 200, a fleet assessment request is received by the first computing device in 205. The fleet assessment request, input signals, and other indicators discussed below may be received in the form of an email, ftp message, instant message, webpage upload, or other form of electronic communication that may be apparent to a person of ordinary skill in the art. In some implementations, the fleet assessment request may be transmitted from the second computing device using an application or software package stored on the second computing device. Further, in some implementations, the application or software package may require a secure login from a user of the second computing device to establish a secure connection with the first computing device and authenticate that the fleet assessment request is being sent by an authorized user. This login or authentication may be performed using a user name/password combination, a biometric scan, or any other unique identification scheme that may be apparent to a person of ordinary skill in the art.

Once the first computing device receives the fleet assessment request, the first computing device can transmits fleet summary information to the second computing device to be displayed by the second computing device in 210. Based on the transmitted fleet summary information in 210, a piece of equipment from the fleet of equipment is selected by a customer using a user interface as discussed below and the first computing device receives an input signal from the second computing device in 215.

Generally the user interfaces of FIGS. 3-11 may be generated and displayed by the second computing devices to display the information and data received from the first computing device. For example, the user interfaces 300, 400, 500, 600 shown in FIGS. 3-6 discussed above may be used to display the fleet summary information received from the first computing device on the second computing device, and may allow a user to select a piece of equipment by clicking, activating, or selecting one or more of the icons, links, or other user interface elements described above. The second computing device may transmit the input signal to the first computing device based on the selection by the user and the input signal may be received by the first computing device in 215.

Specifically, user interfaces 300 may be used to display a general overview of the fleet equipment organized into different categories and user interface 400 may be used to display fleet summary information based on geographic location of the equipment. Additionally, using user interface 400, a customer may narrow the displayed geographic locations of equipment by using the menu 415 or by manipulating the globe 465.

User interface 500 may be used to display the narrowed subset of geographic locations. Further, using the user interface 500, a specific equipment location or facility may be selected from narrowed subset of equipment of the fleet selected by the user. Further, user interface 600 may be used to display the equipment located at the specific location or facility selected using user interface 500. A user may select a specific piece of equipment for review and assessment using the user interface 600. Based on the selection of a specific piece of equipment, the input signal may be sent from the second computing device to the first computing device and received by the first computing device in 215 above.

Returning to the process 200 of FIG. 2, in response to the received input signal in 215, the first computing device may transmit equipment summary information for the selected piece of equipment in 220. The transmitted equipment summary information may include:
Equipment identification information (e.g. Manufacturer information, Model information, serial number information, part number identification, etc.);
Equipment technical information (e.g. Rated performance information, Measured Actual performance information, Identified/known defects or technical bulletins issued by manufacturer since equipment manufactured, type or configuration of equipment or subsystem (such as type of combustion system, a type of fuel injector, a type of control system/display system/fire detection system/gas detection system/vibration system/fuel valve/starter, etc.), and any other technical information that may be useful);
Age of the selected piece of equipment (e.g. when manufactured, when installed, when last repaired, etc.);
Risk of Failure assessment data (e.g. probability of system or subsystem failure based on known technical issues with manufacturer or model, age of equipment, maintenance history, etc.);
Risk of Obsolescence assessment data (e.g. probability that system or subsystems could be difficult or impossible to repair due to type of system or subsystems have become obsolete causing difficulties of finding replacement parts and/or service personnel qualified to repair).

In addition to the equipment summary information, the first computing device may also provide summaries of available media associated with piece of equipment selected in 215. For example, the first computing device may transmit summaries of photos, technical service bulletins issued by manufacturer regarding known defects and/or recommended modifications, original design schematics, original product support documents (e.g. user manuals, service manuals, tutorials, checklists, etc.), and any other media that may be relevant to the selected piece of equipment as may be apparent to a person of ordinary skill in the art.

In response to the transmitted available equipment summary data in 220, the first computing device may receive an input signal selecting a category or subset of the available equipment summary data in 225.

The user interface 700 of FIG. 7 may be used to show the available equipment summary information for the selected piece of equipment transmitted in 220 and to provide a mechanism for transmitting the input signal selecting a category or subset of the available equipment summary data received by the first computing device in 225. Specifically, a user may select categories or subsets of detailed data for review by using the menu 715 and/or selecting any of the display areas 725, 755, 760 of user interface 700. When a user selects a link from the menu 715 and/or selects one of the display areas 725, 755, 760, the second computing device may send the input signal to the first computing device that is received in 225.

Returning to the process 200 of FIG. 2, in 230 the first computing device may transmit detailed data corresponding to the category or subset of data selected by the input signal received in 225. FIGS. 9 and 10 illustrate user interfaces 800, 900 providing examples of the detailed data transmitted by the first computing device to the second computing device to be displayed to the user.

In addition to transmitting detailed data to the second computing device in 230, in some implementations, the first computing device may transmit past performance data of one or more individual pieces of equipment and/or the entire fleet to the second computing device in 235. For example, the first computing device may transmit repair data or downtown data indicating how frequently equipment has been down due to repairs based on information from the customer's maintenance records. As another example, the first computing device may transmit efficiency data indicating whether equipment was operating efficiently or inefficiently based on the technical data gathered by the OEM or consultant. In both of these examples, the first computing device may also transmit lost production data estimating how much production was lost due to the equipment being offline or operating inefficiently based on the Customer's business records. The past performance data is not particularly limited and may be any form of past performance data that may be apparent to a person of ordinary skill in the art.

Additionally, in some implementations, the past performance information of the individual pieces of equipment and/or the entire fleet may be correlated to the equipment data stored on the first computing device in 240. For example, the repair/downtime data, or the lost production data may be correlated with the manufacturer, model, age, working environment, or any other equipment data stored on the first computing device. These correlations may indicate that equipment older than a certain threshold or manufactured by a certain manufacturer is down more frequently or causes greater production losses than newer equipment or equipment manufactured by a different manufacturer. The correlations between past performance data and equipment data are not particularly limited and may be any correlations that may be apparent to a person of ordinary skill in the art.

In some implementations the first computing device may also transmit recommendations, based on the correlations made in 240, for taking courses of action to improve future performance in 245. For example, the first computing device may transmit recommendations to replace equipment older than the threshold, or replace equipment manufactured by a particular manufacturer. The recommendations are not particularly limited and may be any recommendations that may be apparent to a person of ordinary skill in the art based on the correlations made in 240.

FIGS. 10 and 11 illustrate user interfaces 1000, 1100 providing examples of the past performance data, correlations, and recommendations transmitted by the first computing device in 235, 240, and 245 to the second computing device to be displayed to the user.

Returning to the process 200 of FIG. 2, in addition transmitting the past performance data, correlations, and recommendations to the second computing device in 235, 240, and 245, in some implementations, the first computing device may also send out notifications to the second computing device indicating that updates to any of the data, correlations, and recommendations are available to be accessed in 250. In some implementations, the indicator may also be sent as a pop-up interface with a click-through acceptance interface being displayed to a user on the second computing device. If the user clicks through the pop-up interface, an acknowledgement may be sent to the first computing device.

After the first computing device has sent the indication that an update is available in 250, a response acknowledging the update may be received by the first computing device, and the first computing device may trigger a billing transaction using a computer controlled billing system in 255. For example, the first computing device may send a signal to an electronic billing system to generate an invoice and transmit the invoice to the customer.

Those of skill will appreciate that the various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, block, or step is for ease of description. Specific functions or steps can be moved from one module or block without departing from the invention.

The various illustrative logical blocks and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor (e.g., of a computer), or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A computer-implemented method, for providing an assessment of equipment in an equipment fleet, the method comprising:
receiving, by a first computing device, an equipment assessment request from a second computing device;
transmitting, by the first computing device, fleet summary information representative of a plurality of pieces of equipment in the equipment fleet based on fleet composition data stored on the first computing device to the second computing device, the fleet summary information comprising a graphical representation of the plurality of pieces of equipment based on one or more of:
age of equipment;
geographic location of equipment;
manufacturer of equipment;
model of equipment;
receiving, by the first computing device, a first input selecting one piece of equipment from the plurality of pieces of equipment from the second computing device;
transmitting, by the first computing device, equipment summary information representative of categories of available summary data for the selected piece of equipment stored on the first computing device to the second computing device, the categories of available summary data including:
equipment identification information;
equipment technical information;
age of the selected piece of equipment;
risk of failure assessment data; and
risk of obsolescence assessment data;
receiving, by the first computing device, a second input selecting one of the categories of available summary data from the second computing device; and
transmitting, to the second computing device, detailed data stored on the first computing device, the detailed data corresponding to the selected category of available summary data.

2. The method of claim 1, wherein transmitting the fleet summary information further comprises:
transmitting the fleet summary information of the entire fleet of equipment.

3. The method of claim 1, wherein the detailed data comprises:
data collected from one or more sensors monitoring one or more of the pieces of equipment; and
maintenance data collected during location visits.

4. The method of claim 1, further comprising transmitting to the second computing device past performance summary data of the plurality of pieces of equipment in the equipment fleet.

5. The method of claim 4, further comprising:
correlating the past performance summary data of the plurality of pieces of equipment to the detailed data stored on the first computing device;
transmitting, to the second computing devices, recommended courses of action to improve performance based on the correlations between the past performance data and the detailed data stored on the first computing device.

6. The method of claim 5, wherein the recommended courses of action comprises one or more of:
replacement of one or more particular pieces of equipment based on the age;
replacement of one or more subsystems of one or more particular pieces of equipment based on the age;
repair of one or more particular pieces of equipment based on the age;
repair of one or more subsystems of one or more particular pieces of equipment based on the age;
replacement of one or more particular pieces of equipment based on obsolescence of technology;
replacement of one or more subsystems of one or more particular pieces of equipment based on obsolescence of technology.

7. The method of claim 1, further comprising transmitting, to the second computing device, a graphical representation indicating that an update to the detailed data stored on the first computing device has been installed;
receiving, by the first computing device, an acknowledgement from second computing device that the update of the detailed data has been installed; and
initiating a billing transaction based on the acknowledgment being received by the first computing device.

8. A non-transitory computer readable medium having stored therein computer executable instructions for causing a first computing device to perform a method for providing an assessment of equipment in an equipment fleet, the method comprising:
receiving, by a first computing device, an equipment assessment request from a second computing device;
transmitting, by the first computing device, to the second computing device fleet summary information representative of a plurality of pieces of equipment in the equipment fleet based on fleet composition data stored on the first computing device, the fleet summary information comprising a graphical representation of the plurality of pieces of equipment based on one or more of:
age of equipment;
geographic location of equipment;
manufacturer of equipment;
model of equipment;
receiving, by the first computing device, a first input selecting one piece of equipment from the plurality of pieces of equipment from the second computing device;
transmitting, by the first computing device, equipment summary information representative of categories of available summary data for the selected piece of equipment stored on the first computing device, the categories of available summary data including:
equipment identification information;
equipment technical information;
age of the selected piece of equipment;
risk of failure assessment data; and
risk of obsolescence assessment data;
receiving, by the first computing device, a second input selecting one of the categories of available summary data from the second computing device; and
transmitting, to the second computing device, detailed data stored on the first computing device, the detailed data corresponding to the selected category of available summary data.

9. The non-transitory computer readable medium of claim 8, wherein transmitting the fleet summary information further comprises:
transmitting the fleet summary information of the entire fleet of equipment.

10. The non-transitory computer readable medium of claim 8, wherein the detailed data comprises:
data collected from one or more sensors monitoring one or more of the pieces of equipment; and
maintenance data collected during location visits.

11. The non-transitory computer readable medium of claim 8, further comprising transmitting to the second computing device past performance summary data of the plurality of pieces of equipment in the equipment fleet.

12. The non-transitory computer readable medium of claim 11, further comprising:
correlating the past performance summary data of the plurality of pieces of equipment to the detailed data stored on the first computing device;
transmitting, to the second computing devices, recommended courses of action to improve performance based on the correlations between past performance data and the detailed data stored on the first computing device.

13. The non-transitory computer readable medium of claim 12, wherein the recommended courses of action comprises one or more of:
replacement of one or more particular pieces of equipment based on the age;
replacement of one or more subsystems of one or more particular pieces of equipment based on the age;
repair of one or more particular pieces of equipment based on the age;
repair of one or more subsystems of one or more particular pieces of equipment based on the age;
replacement of one or more particular pieces of equipment based on obsolescence of technology;
replacement of one or more subsystems of one or more particular pieces of equipment based on obsolescence of technology.

14. The non-transitory computer readable medium of claim 8, further comprising transmitting, to the second computing device, a graphical representation indicating that an update to the detailed data stored on the first computing device has been installed;
receiving, by the first computing device, an acknowledgement from second computing device that the update of the detailed data has been installed; and
initiating a billing transaction based on the acknowledgment being received by the first computing device.

15. A computing device comprising storage and a processor configured to perform:
receiving an equipment assessment request from a second computing device;
transmitting fleet summary information representative of a plurality of pieces of equipment in the equipment fleet based on fleet composition data stored in the storage to the second computing device, the fleet summary information comprising a graphical representation of the plurality of pieces of equipment based on one or more of:
age of equipment;
geographic location of equipment;
manufacturer of equipment;
model of equipment;
receiving a first input selecting one piece of equipment from the plurality of pieces of equipment from the second computing device;
transmitting equipment summary information representative of categories of available summary data for the selected piece of equipment stored in the storage, to the second computing device, the categories of available summary data including:
equipment identification information;
equipment technical information;
age of the selected piece of equipment;
risk of failure assessment data; and
risk of obsolescence assessment data;
receiving a second input selecting one of the categories of available summary data from the second computing device; and
transmitting to the second computing device detailed data stored on the first computing device, the detailed data corresponding to the selected category of available summary data.

16. The computing device of claim 15, wherein transmitting the fleet summary information further comprises:
transmitting the fleet summary information of the entire fleet of equipment.

17. The computing device of claim 15, wherein the detailed data comprises:
data collected from one or more sensors monitoring one or more of the pieces of equipment; and
maintenance data collected during location visits.

18. The computing device of claim 15, further comprising transmitting to the second computing device past performance summary data of the plurality of pieces of equipment in the equipment fleet.

19. The non-transitory computer readable medium of claim 18, further comprising:
correlating past performance summary data of the plurality of pieces of equipment to the detailed data stored in the storage;
transmitting, to the second computing devices, recommended courses of action to improve performance based on the correlations between past performance data and the detailed data stored in the storage;
wherein the recommended courses of action comprises one or more of:
replacement of one or more particular pieces of equipment based on the age;
replacement of one or more subsystems of one or more particular pieces of equipment based on the age;
repair of one or more particular pieces of equipment based on the age;
repair of one or more subsystems of one or more particular pieces of equipment based on the age;
replacement of one or more particular pieces of equipment based on obsolescence of technology;
replacement of one or more subsystems of one or more particular pieces of equipment based on obsolescence of technology.

20. The computing device of claim 15, further comprising transmitting to the second computing device a graphical representation indicating that an update to the detailed data stored on the first computing device has been installed;
receiving an acknowledgement from the second computing device that the update of the detailed data has been installed; and
initiating a billing transaction based on the acknowledgment being received.
